(19) United States
(12) Patent Application Publication
(10) Pub. No.: US 2013/0081654 A1
(43) Pub. Date: Apr. 4, 2013

(54) METHOD TO CLEAN GAS TURBINE FUEL CHAMBER COMPONENTS

(71) Applicants: Daniel Thomas Harvell, Cornelius, NC (US); Gregory Douglas Troutman, Midlothian, VA (US); Michael Gerard Lynch, Villa Rica, GA (US)

(72) Inventors: Daniel Thomas Harvell, Cornelius, NC (US); Gregory Douglas Troutman, Midlothian, VA (US); Michael Gerard Lynch, Villa Rica, GA (US)

(73) Assignee: General Electric Company, Schenectady, NY (US)

(21) Appl. No.: 13/249,852

(22) Filed: Sep. 30, 2011

(51) Int. Cl. B08B 9/02; B08B 9/043; B08B 9/035; B08B 9/04

(52) U.S. Cl. 134/8

(57) ABSTRACT

Disclosed herein is a method for cleaning the annulus chamber of forward combustion cans of a gas turbine. The method comprises the steps of feeding a cable through at least half the annulus chamber in a first direction and then rotating the cable. The annulus chamber is then aerated to remove dislodged debris.

### BACKGROUND OF THE INVENTION

The subject matter disclosed herein relates to the cleaning of gas turbine combustion cans.

Certain gas turbines, such as General Electric F-Series gas turbines using quaternary fuel, have components that are constructed of mild steel. Debris, including iron oxide corrosion products, may form inside fuel pathways or channels of the turbine combustion casings, or “cans”. For example, FIGS. 1 and 2 schematically illustrate a General Electric F-Series gas turbine forward combustion can having a quaternary fuel circuit. A quaternary fuel gas inlet orifice leads to a quaternary fuel gas distribution annulus chamber extending around the circumference of the forward combustion can. The fuel gas in the quaternary annulus chamber is distributed by multiple quaternary pegs (e.g., 18 pegs or another number of pegs) into the forward combustion chamber. When inspection of the forward casing indicates debris build-up, cleaning of the quaternary annulus is recommended. As can be appreciated, the quaternary fuel gas distribution annulus chamber is a narrow passageway and is difficult to access.

At present, one method of mechanically cleaning the quaternary fuel gas distribution annulus chamber involves cutting off the fuel pegs followed by attempts to hydro-blast the iron deposits by gaining access to the quaternary annulus channel via the fuel peg holes. Another method of cleaning the quaternary fuel gas distribution annulus chamber involves the use of chemical rinsing agents. Yet another method of cleaning the quaternary fuel gas distribution annulus chamber involves the use of a lubricant and round objects placed in the chamber that is then shaken by large equipment to dislodge any debris. In many cases, these existing cleaning processes require removal of the combustor cans from the turbine and shipment offsite, which can be time consuming and costly.

It would be desirable to provide a rapid method to clean critical fuel pathways in a gas turbine thus removing the potential for iron deposits to block fuel gas passages. The discussion above is merely provided for general background information and is not intended to be used as an aid in determining the scope of the claimed subject matter.

### BRIEF DESCRIPTION OF THE INVENTION

A method is disclosed, wherein the annulus chamber of a gas turbine fuel chamber is cleaned. An advantage that may be realized in the practice of some disclosed embodiments of the method is that it is possible to clean the annulus chamber while the fuel chamber is mounted to the turbine (i.e. removal is not required) without resorting to chemical cleaning agents.

In one exemplary embodiment, a method for cleaning an annulus chamber is disclosed. The method comprises the steps of feeding a cable through the annulus chamber in a first direction to a position at least 180 degrees from the fuel inlet orifice and then rotating the cable. The annulus chamber is then aerated to remove dislodged debris.

In another exemplary embodiment, the method comprises the steps of feeding a vacuuming tool through the annulus chamber followed by feeding a cable through the annulus chamber in a first direction to a position at least 180 degrees from the fuel inlet orifice and then rotating the cable. The annulus chamber is then aerated to remove dislodged debris.

In another exemplary embodiment, a method for cleaning an annulus chamber is disclosed. The method comprises the steps of feeding a vacuuming tool through the annulus chamber followed by feeding a cable through the annulus chamber in a first direction to a position at least 270 degrees from the fuel inlet orifice and then rotating the cable. The cable is then fed through the annulus in a second direction to a position at least 270 degrees from the fuel inlet orifice and is then rotated. The annulus chamber is then aerated to remove dislodged debris.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of invention. In the drawings, like numerals are used to indicate like parts throughout the various views. Thus, for further understanding of the invention, reference can be made to the following detailed description, read in connection with the drawings in which:

FIG. 1 illustrates a forward combustion can of a gas turbine;

FIG. 2 illustrates an enlarged cut away view of the forward combustion can of FIG. 1 illustrating the quaternary fuel gas distribution annulus chamber;

FIG. 3 is an enlarged view of a portion of the cleaning system illustrating a quaternary fuel flange of the forward combustion can;

FIG. 4 depicts a process flow diagram of one method for cleaning an annulus chamber;

FIG. 5 is a view of an adapter that includes air inlet and air outlets;

FIG. 6. depicts a forward combustion can with an adapter attached being cleaned;

FIG. 7 shows an adaptor for attaching to a fuel flange; and

FIG. 8 shows an example of a tool for use with the present method.

### DETAILED DESCRIPTION OF THE INVENTION

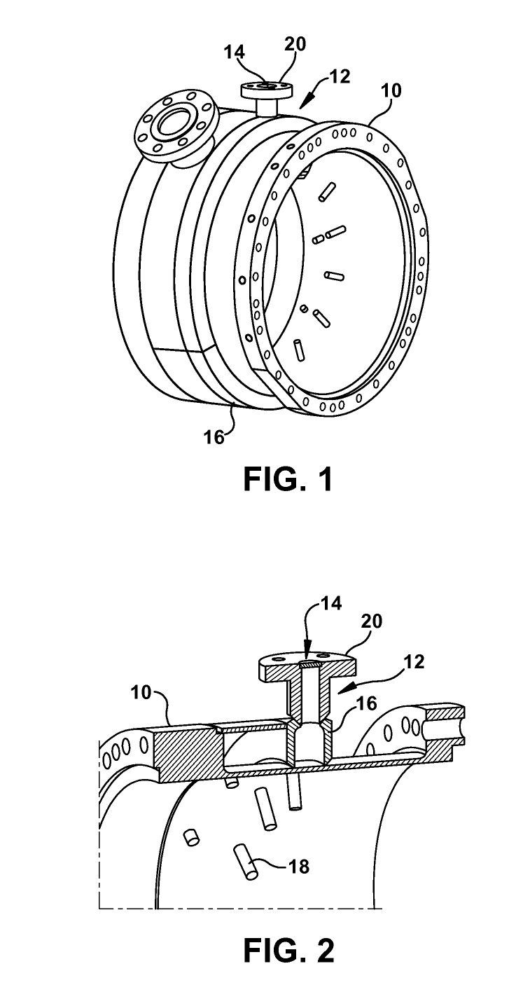

FIGS. 1 and 2 illustrate a forward combustion can 10, of the type used in gas turbines such as General Electric F-Series gas turbines. A typical gas turbine has several such forward combustion cans 10. The forward combustion can 10 has a quaternary fuel circuit 12 with a quaternary fuel gas inlet orifice 14 leading to a quaternary fuel gas distribution annulus chamber 16 extending around the circumference of the forward combustion can 10. Inlet orifice 14 is flanked by quaternary fuel flange 20 which facilitates the attachment of instruments to inlet orifice 14. The fuel gas in the quaternary annulus chamber 16 is distributed by multiple quaternary pegs 18 into the combustion chamber of the forward combustion can 10.

It is known that deposits (e.g. iron oxide corrosion products, dust and other debris) collect in the quaternary annulus chamber 16 and may result in blockage of fuel gas passages in the quaternary pegs 18. This potentially interferes with the flame pattern in the combustion chamber of the forward combustion can 10. The method disclosed is directed to a method of removing this debris from the quaternary annulus chamber 16 of the forward combustion cans 10. The forward combustion cans 10 are cleaned at a repair facility or on-site with a mobile cleaning unit using a novel procedure such that the cans 10 can be cleaned within a matter of a few hours or days rather than the weeks conventional methods required. The described embodiments contemplate both removing the forward combustion cans 10 from the turbine as well as cleaning the combustion cans 10 while in place on the turbine. Both such embodiments are within the scope of the invention.

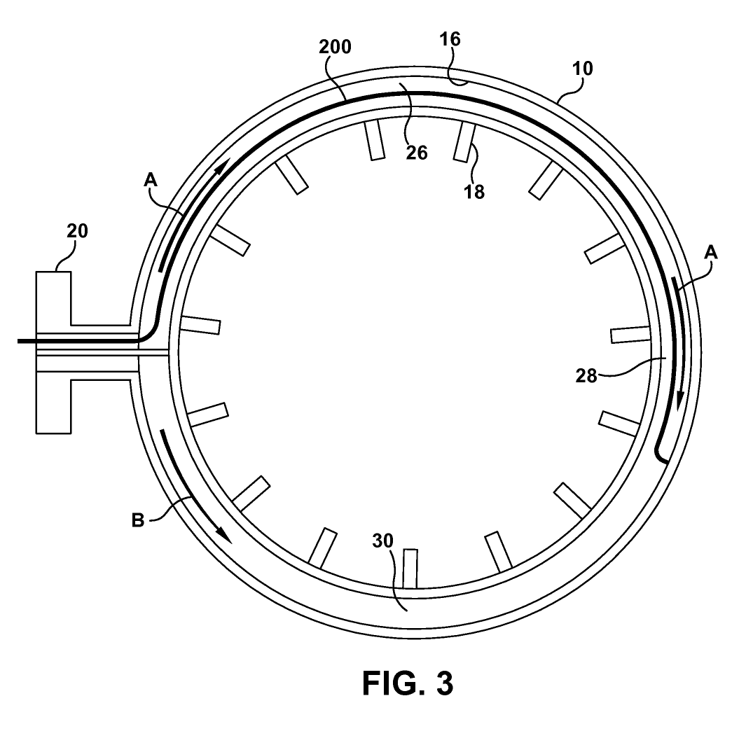

Generally, as depicted in FIG. 3, a variety of different tools 200, described elsewhere in this specification, are fed through annulus chamber 16 in a circumferential direction (e.g. clockwise or counter-clockwise) to a position relative to the fuel inlet orifice 14. The position may be 180 degrees to 360 degrees from the fuel inlet orifice 14, and all subranges therebetween. Example of such tools include borescopes, vacuuming tools, rotating cables and vent brushes. In the embodiment depicted in FIG. 3, tool 200 is fed past first position 26 (90 degrees from the fuel inlet orifice 14) to at least the second position 28 (180 degrees from the fuel inlet orifice 14). In other embodiments, the tool is fed to at least the third position 30 (270 degrees from the fuel inlet orifice 14). In another embodiment, the cleaning is extended to about 360 degrees (i.e., throughout the entire annulus chamber 16). In those embodiments where the tool is fed to a position at least 270 degrees from the fuel inlet orifice 14 in two different circumferential directions, a certain degree of overlap is provided. In certain embodiments, two feeding steps are utilized where the tool 200 extends in two different circumferential directions to a position at least 180 degrees from the fuel inlet orifice 14, such that the full length of the annulus chamber is cleaned.

Referring to FIG. 3 a method 100 for cleaning a quaternary fuel gas distribution annulus chamber 16 is depicted. In one embodiment, a borescope probe is inserted into the annulus chamber in step 102 to permit visual inspection of the chamber. Such an inspection step can occur before cleaning (step 102), after cleaning, (step 118) both before and after cleaning, and/or even during the cleaning process. To demonstrate the success of the cleaning method, images may be captured before cleaning (to show the need to clean), after cleaning (to show cleaning was successful) or both before and after (to provide a comparison). Any suitable image capturing method may be used including, for example, digital image capturing. The images may be taken at any position along the length of the annulus from about 5 degrees from the fuel inlet orifice 14 to about 355 degrees from the fuel inlet orifice 14. Images are typically taken after the borescope has made the bend (e.g., 5 degrees) after entering the annulus chamber 16 and is orientated to face the length of the chamber. In those embodiments where images are captured, the images provide a record of the amount of debris present in the annulus chamber 16 prior to, or after, cleaning. In one embodiment, at least four images are captured at different points along the annulus chamber (e.g. about 5, 90, 180 and 355 degrees from the fuel inlet orifice 14).

At first vacuuming step 104, a first end of an elongated vacuuming tool is inserted through the fuel inlet orifice 14 and into the annulus chamber 16 in a first circumferential direction. For example, and with reference to FIG. 3, in one embodiment the first circumferential direction is direction A (clockwise). In another embodiment, the first circumferential direction is direction B (counter-clockwise). The vacuuming tool may be fed into the annulus chamber 16 from 180 degrees to 360 degrees from the fuel inlet orifice 14, and all subranges therebetween. In one embodiment, wherein the first circumferential direction is direction A, the vacuuming tool is fed past first position 26 (the 90 degree position) to at least the second position 28 (180 degree position). In another embodiment, the vacuuming tool is fed past first position 26 to at least third position 30 (the 270 degree position). In yet another embodiment, the vacuum tool is fed through the length of the annulus chamber 16. During step 104, the vacuuming action of the tool removes bulk debris from the annulus chamber 16. The size of the elongated vacuuming tool is selected based on the size of the annulus chamber 16. For example, in one embodiment the annulus chamber is about 5 cm wide and the vacuuming tool is from 1.0 to 1.5 cm wide. After step 104 is completed, the vacuuming tool is removed from annulus chamber 16 and second vacuuming step 106 is executed.

At second vacuuming step 106 the first end of the elongated vacuuming tool is inserted through the fuel inlet orifice and into the annulus chamber 16 in a second circumferential direction, opposite the first circumferential direction. The vacuuming tool may be fed into the annulus chamber 16 from 180 degrees to 360 degrees from the fuel inlet orifice 14, and all subranges therebetween. Second vacuuming step 106 is particularly useful for those embodiments where the first vacuuming step traverses less than the full length of the annulus chamber 16. After step 106 is completed, the vacuuming tool is removed from annulus chamber 16.

At first rotary cleaning step 108, a first end of an elongated cleaning cable is inserted through the fuel inlet orifice 14 and into the annulus chamber 16 in a first circumferential direction. The first circumferential direction of step 108 (rotary cleaning) may be the same or opposite the first circumferential direction of step 104 (vacuuming). Like the feeding step of the vacuuming tool (when the tool is passed in circumferential direction A) the cable passes first position 26 (90 degrees from the fuel inlet orifice 14) to at least second position 28 (180 degrees from the fuel inlet orifice 14). In another embodiment, the cable passes first position 26, second position 28 to reach at least to third position 30 (270 degrees from the fuel inlet orifice 14). Any suitable elongated cleaning cable may be used including, for example, the cable commonly used in speedometers. In one embodiment the cable is encased in a protective sheath (e.g. a polymeric sheath) to protect the walls of annulus chamber 16 from damage. In one embodiment, the first end of the cable is bent to provide a hook, for example, a 90 degree bend, or is attached to a suitable cleaning tool for dislodging debris. Advantageously, this hooked-end assists in removing debris during subsequent rotational cleaning steps.

First rotational step 110 is executed by attaching the second end of the cable to a rotary instrument such as a manual rotary tool or power rotary tool (e.g. DREMEL brand rotary tool or an air die grinder). The activation of the rotary tool causes the cable to rotate within the confines of annulus chamber 16 about the longitudinal axis that stretches over the cable's length. Advantageously, this rotary action of the cable dislodges debris from the inner wall surface of annulus chamber 16 without resorting to chemical cleaning agents. This minimizes the costs associated with the disposal of such cleaning agents. In certain embodiments, the rotary instrument is operated at one of its lower power settings as higher settings can entangle the cable and/or cause elements to overheat due to frictional forces. In one embodiment, the cable is slowly withdrawn as it rotates. In another embodiment, the cable is rotated, stopped, and then withdrawn. By way of illustration and not limitation, the cable may be withdrawn over a period of two to three minutes. After step 110 is completed, the elongated cable is withdrawn and steps 112 and 114 are executed.

Steps 112 and 114 are similar to steps 108 and 110 except in that the cable is fed about the annulus chamber 16 in a second circumferential direction that is opposite the first circumferential direction of step 108. In step 116, a vent brush is passed through the annulus chamber 16. In one embodiment, the vent brush has bristles that span the diameter of the annulus chamber 16. The vent brush may be passed to the 180 degree position and subsequently withdrawn, passed to the 270 degree position and then withdrawn, or passed through the entire length of the annulus chamber. In one embodiment, the vent brush is passed through annulus chamber two or more times. In another embodiment, the vent brush is passed through the annulus chamber three or more times. In one embodiment, the vent brush is about 2.4 meters long with bristles at a first end of the elongated, flexible vent brush.

In step 118, the annulus chamber 16 is aerated by first attaching an adapter to the fuel flange 20 that includes an air inlet and an air outlet. The flowing air pushes dislodged debris out of the air outlet. In one embodiment, the air outlet is connected to a vacuum. Pressurized air is supplied to the air inlet. The air travels through the annulus chamber 16 and exits the air outlet. In one embodiment, about 3.5 to about 10.5 atmospheres of pressure is delivered to the air inlet. In another embodiment, about 6.0 to 7.0 atmospheres of pressure is delivered. The air flow is continued for a predetermined period of time. In one embodiment, the air flow is continued for fifteen seconds to a minute. In another embodiment, the air flow is continued for thirty to forty-five seconds.

In step 120, a post-cleaning visual inspection of annulus chamber 16 is conducted with a borescope. Step 120 is substantially similar to step 102 (pre-cleaning visual inspection).

The aforementioned steps can be performed while the forward combustion can 10 is removed from the turbine or while it is still mounted to the turbine. In those embodiments where the steps are performed while it is removed from the turbine, the inner fuel pegs 18 are accessible. Such an embodiment provides an opportunity also clean the pegs 18.

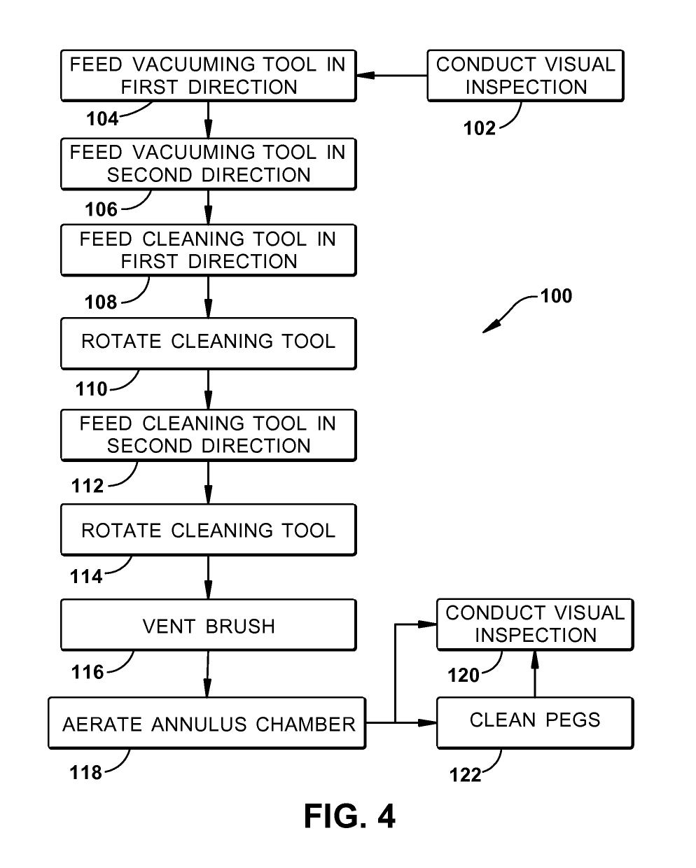

Referring again to FIG. 4, in step 122, bulk debris is removed from the pegs 18 with a wire brush. Also in step 122, compressed air is passed through the pegs 18. In one such embodiment, a rubber adapter establishes a seal between a compressed air hose and the pegs 18. Air is sent through the pegs 18 while a vacuum removes air from the annulus. Using this procedure, any obstructed pegs 18 can be cleared. A borescope probe with a suitable diameter can be used to verify the integrity of the pegs 18 by passing the probe through the hole in the pegs 18. In the event additional cleaning of the pegs 18 is desired, a wire may be attached to a rotary instrument. Once the wire has been inserted into the peg 18, the rotary instrument is activated and the wire is slowly removed as it rotates.

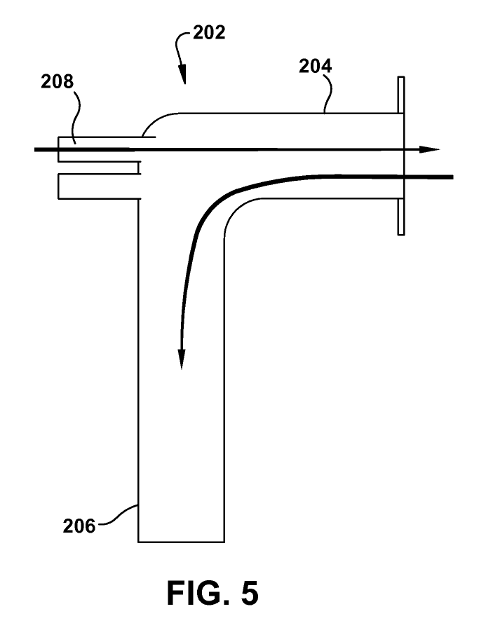

Referring now to FIG. 5, one suitable adapter 202 is depicted that attaches to fuel flange 20 for use during aeration step 118. Adapter 202 includes a first end 204 configured to attach to fuel flange 20 and form a seal therewith. Second end 206 functions as the air outlet and, in the embodiment depicted, is configured to attach to a vacuum (not shown). For example, second end 206 may have a 9.5 mm inner diameter outlet for connecting to a vacuum hose. Adapter 202 includes at least one air inlet 208 adapted to receive pressured air from a hose. Air inlet 208 can be aligned in a straight line with respect to first end 204 such that a hose carrying pressurized air can be fed through air inlet 208, and into the annulus chamber 16 in either a first or second circumferential direction, depending on the orientation of the hose. In one embodiment, the adapter includes two air inlets that feed the hose in the first and second circumferential direction respectively. Since only one air inlet is used at a time, the un-used air inlet may be sealed with a plug to maintain the integrity of the vacuum.

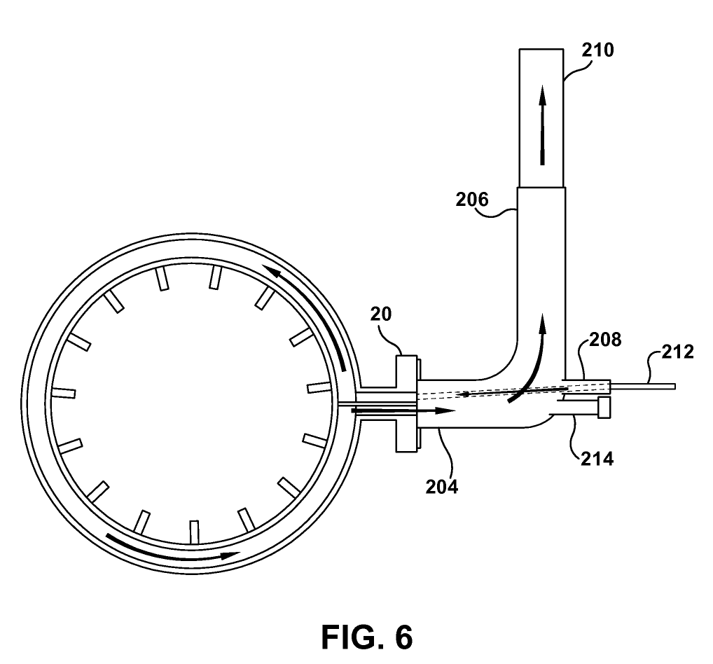

FIG. 6 shows adapter 202 in use. First end 204 is sealed to fuel flange 20. Clamps (not shown) are used during the cleaning to maintain an adequate seal. Air outlet 206 is connected to vacuum hose 210 connected to a vacuum (not shown). Suitable vacuums include a five horse power vacuum with a 1.8 meter hose (5.0 cm inner diameter). First air inlet 208 includes air hose 212. Second air inlet 214 has been sealed with a rubber plug.

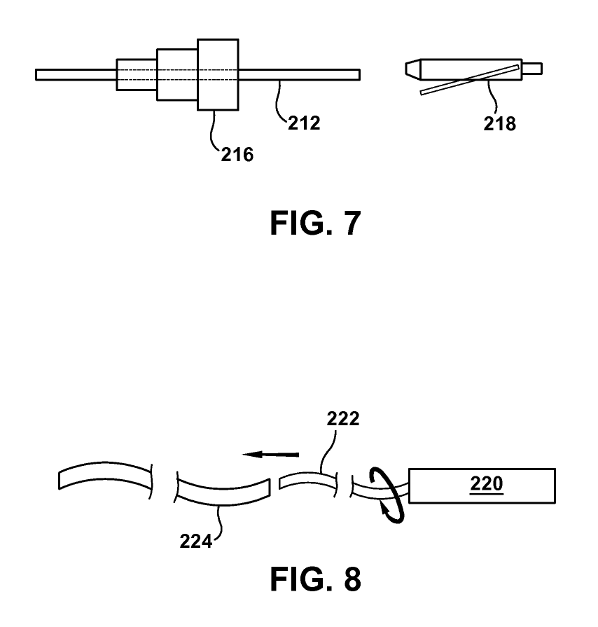

FIG. 7 depicts another adapter 216 for attaching to fuel flange 20. The air inlet includes air hose 212. Air nozzle 218 fits to hose 212 and connects to an air compressor (not shown) via a quick-connect.

FIG. 8 illustrates a tool for use with the present method. Rotary tool 220 attaches to the second end of a cable 222. In the embodiment depicted, the cable includes sheath 224. Sheath 224 is formed of polymeric material and provides a surface that will not damage the inside of annulus chamber 16 during the rotation step. Cable 222 is a semi-flexible metal that provides a degree of rigidity to the cable to enable it to mechanically dislodge debris. In use, cable 222 is inserted into sheath 224 and the resulting cable is fed into annulus chamber 16.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of cleaning quaternary fuel gas distribution annulus chambers in forward combustion cans of a gas turbine, wherein each forward combustion can has a quaternary fuel inlet orifice leading to the quaternary annulus chamber, the method comprising the steps of:
feeding a first end of a cable through the annulus chamber in a first circumferential direction to a position at least 180 degrees from the fuel inlet orifice;
rotating the cable about its longitudinal axis to dislodge debris; and
aerating the annulus chamber by passing air therethrough.

2. The method as recited in claim 1, wherein the steps of rotating the cable includes the step of simultaneously withdrawing the cable from the annulus chamber as it rotates.

3. The method as recited in claim 1, the method further comprising the steps of feeding the cable through the annulus chamber in a second circumferential direction to a position at least 180 degrees from the fuel inlet orifice, the second circumferential direction being opposite the first circumferential direction and thereafter rotating the cable about its longitudinal axis to dislodge debris.

4. The method as recited in claim 3, wherein the step of feeding the cable through the annulus chamber in the second circumferential direction proceeds to a position at least 270 degrees from the fuel inlet orifice.

5. The method as recited in claim 1, further comprising the step of attaching an adapter to the fuel inlet orifice, the adapter including an air inlet that directs air through the annulus chamber during the aeration step and an air outlet that receives dislodged debris.

6. The method as recited in claim 5, wherein the air outlet is connected to a vacuum.

7. The method as recited in claim 5, wherein the aeration step directs air through the annulus chamber in a first aeration direction selected from the first circumferential direction and the second circumferential direction.

8. The method as recited in claim 7, wherein the aeration step further comprises the step of directing air through the annulus chamber in a second aeration direction that is opposite the first aeration direction.

9. A method of cleaning quaternary fuel gas distribution annulus chambers in forward combustion cans of a gas turbine, wherein each forward combustion can has a quaternary fuel inlet orifice leading to the quaternary annulus chamber, the method comprising the steps of:
feeding a vacuuming tool through the annulus chamber to a position at least 180 degrees from the fuel inlet orifice and removing debris therefrom with the vacuuming tool;
feeding a first end of a cable through the annulus chamber in a first circumferential direction to a position at least 180 degrees from the fuel inlet orifice;
rotating the cable about its longitudinal axis to dislodge debris; and
aerating the annulus chamber by passing air therethrough to remove dislodged debris from the annulus chamber and providing debris to a vacuum connected to the annulus chamber.

10. The method as recited in claim 9, wherein the step of aerating the annulus chamber passes air into an air inlet, through the annulus chamber, and out of an air outlet, wherein both the air inlet and air outlet are attached to the fuel inlet orifice.

11. The method as recited in claim 9, wherein the step of feeding the vacuuming tool through the annulus chamber is fed in the first circumferential direction.

12. The method as recited in claim 9, wherein the step of feeding the vacuuming tool through the annulus chamber is fed in a second circumferential direction that is opposite the first circumferential direction.

13. The method as recited in claim 9, wherein the method is performed while the forward combustion can is mounted to the turbine.

14. The method as recited in claim 9, wherein the method is performed while the forward combustion can is separated from the turbine, the method further including the step of cleaning at least one fuel peg of the forward combustion can.

15. The method as recited in claim 9, wherein the steps of rotating the cable comprises the step of simultaneously withdrawing the cable from the annulus chamber as it rotates.

16. The method as recited in claim 9, wherein the step of feeding the cable through the annulus chamber proceeds to a position at least 270 degrees from the fuel inlet orifice.

17. The method as recited in claim 9, further comprising the step of feeding a vent brush through the annulus chamber.

18. The method as recited in claim 9, further comprising the steps of attaching a rotary tool to a second end of the cable and activating the rotating tool to cause the cable to perform the step of rotating the cable about its longitudinal axis.

19. The method as recited in claim 9, further comprising the step of visually inspecting the annulus chamber by feeding a borescope through at least a portion of the annulus chamber.

20. A method of cleaning quaternary fuel gas distribution annulus chambers in forward combustion cans of a gas turbine, wherein each forward combustion can has a quaternary fuel inlet orifice leading to the quaternary annulus chamber, the method comprising the steps of:
feeding a vacuuming tool through the annulus chamber to a position at least the 180 degree position and removing debris therefrom with the vacuuming tool;
feeding a first end of a cable through the annulus chamber in a first circumferential direction to a position at least 270 degrees from the fuel inlet orifice;
rotating the cable about its longitudinal axis;
feeding the first end of the cable through the annulus chamber in a second circumferential direction to a position at least 270 degrees from the fuel inlet orifice and thereafter rotating the cable about its longitudinal axis;
aerating the annulus chamber by passing air therethrough to remove dislodged debris from the annulus chamber and providing debris to a vacuum connected to the annulus chamber.
